(19) United States
(12) Patent Application Publication
(10) Pub. No.: US 2025/0332540 A1
(43) Pub. Date: Oct. 30, 2025

(54) SOLVENT DEGRADATION INHIBITOR IN POST-COMBUSTION CARBON CAPTURE

(71) Applicant: Entropy Inc., Calgary (CA)

(72) Inventors: Raphael Idem, Regina (CA); Teeradet Supap, Regina (CA); Jessica Narku-Tetteh, Regina (CA); Pailin Muchan, Regina (CA); Paweesuda Natewong, Regina (CA)

(21) Appl. No.: 19/189,103

(22) Filed: Apr. 24, 2025

(30) Foreign Application Priority Data
Apr. 26, 2024 (CA) 3236616

(51) Int. Cl. B01D 53/14; B01D 53/62; B01D 53/78

(52) U.S. Cl. CPC B01D 53/1493; B01D 53/1475; B01D 53/62; B01D 53/78; B01D 2252/20484; B01D 2252/604; B01D 2257/504; B01D 2258/0283

(57) ABSTRACT

A degradation inhibitor composition for stabilizing an amine solvent used in a post-combustion carbon capture process is provided. According to a preferred embodiment, the degradation inhibitor comprises: (a) Nitrilotriacetic acid (NTA); or (b) N-(2-hydroxyethyl) ethylenediamine-N′, N′, N″-triacetic acid (HEEDATA). A method of stabilizing an amine solvent used in a post-combustion carbon capture process using the degradation inhibitor compositions described herein is also provided.

### CROSS REFERENCE TO RELATED APPLICATIONS

The subject application claims priority to Canadian Patent Application No. 3,236,616 filed Apr. 26, 2024, the contents of which are incorporated by reference in their entirety.

### FIELD OF INVENTION

The present disclosure is directed to methods and compositions for carbon capture, more specifically, there is disclosed various degradation inhibitors in post-combustion carbon capture processes and methods of using such for minimizing the oxidative degradation of, and associated NH₃ emissions from the degradation of, amine solvents used in said carbon capture processes.

### BACKGROUND OF THE INVENTION

Post-combustion CO₂ capture (PCCC) is a mature technology, which aims to separate CO₂ from a flue gas stream released from industrial processes. PCCC is currently the most promising and mature strategy for CO₂ capture from industrial processes and can be either retrofitted into existing traditional large-scale fossil fuel-fired power plants or built as end-of-pipe removal technology for new plants.

Chemical absorption of CO₂ is a typical process in PCCC by using chemical solvents that are compatible with the composition of the flue gas stream and the heat and pressures involved in the particular PCCC process. The principle of chemical absorption involves a reversible chemical reaction of CO₂ with a chemical solvent in an absorption column, which can form a strong chemical bond between the solvent and the CO₂. Then, the chemical bond is broken to release the captured CO₂ upon exposure to high temperature (˜120° C.) in a stripper column (or desorber column, or regenerator), and the regenerated lean amine solvent solution can be circulated back through the system for another absorption process.

The types of potentially usable chemical solvents are diverse, such as aqueous amine solvents, ionic liquids, non-aqueous amine solvents, ionic liquids with amine solvents, and others. Amine solvents are widely considered to be favourable for use in PCCC processes due to their comparably low price. Certain amine solvents with favourable characteristics for the PCCC process are vulnerable to oxidative degradation and associated NH₃ (ammonia) emissions, resulting in increased costs due to lost solvents and the need to mitigate ammonia emissions.

Therefore, there is a need to develop a novel degradation inhibitor for use in a PCCC process to minimizing the rates of oxidative degradation and NH₃ emissions in the chemical solvent.

### SUMMARY OF THE INVENTION

According to a first aspect of the present invention there is provided a method of stabilizing an amine solvent composition used in a post-combustion carbon capture process to minimize oxidative degradation of such amine solvent; said degradation inhibitor is selected from the group consisting of nitrilotriacetic acid (NTA); N-(2-hydroxyethyl) ethylenediamine-N′, N′, N″-triacetic acid (HEEDATA); and combinations thereof.

According to a preferred embodiment of the present invention, the total molar concentration of the degradation inhibitor is in the range of 0.0001 M to 0.05 M.

According to a preferred embodiment of the present invention, said degradation inhibitor reduces a degradation rate of a 1-(2-hydroxyethyl)pyrrolidine (PR) component in said amine solvent below a rate of 1.00 mM/h.

According to a preferred embodiment of the present invention, said degradation inhibitor reduces the degradation rate of a hexamethylenediamine (HMDA) component in said amine solvent composition below a rate of 0.50 mM/h.

According to a preferred embodiment of the present invention, said degradation inhibitor reduces an NH₃ emission rate from said amine solvent below a rate of 8.00 ppmV/h.

According to another aspect of the present invention, there is provided a method of minimizing the effects of the oxidative degradation of an amine solvent composition in a post-combustion carbon capture process, comprising the steps of:
(a) providing a means to combine said amine solvent with a degradation inhibitor according to a preferred embodiment of the present invention;
(b) providing said amine solvent;
(c) exposing said amine solvent to said means to combine said amine solvent with said degradation inhibitor;
(d) collecting a flue gas comprising carbon dioxide from a flue gas emitting source; and
(e) exposing the treated amine solvent to said flue gas for a period of time sufficient to remove at least a portion of said carbon dioxide gas present in said flue gas.

According to yet another aspect of the present invention, there is provided the use of a degradation inhibitor composition according to a preferred embodiment of the present invention to treat an amine solvent used in a post-combustion carbon capture process by exposing said degradation inhibitor to said amine solvent, thereby minimizing the oxidative degradation of, and associated NH₃ emissions from the degradation of, said amine solvent in said carbon capture process.

### BRIEF DESCRIPTION OF THE FIGURES

Features and advantages of the embodiments of the present invention will become apparent from the following detailed description, taken in combination with the appended figures in which:

FIG. 1 is a representation of the experimental setup for degradation and NH₃ emission studies; and

FIG. 2 is a graphical representation of the NH₃ emission profiles of all tested amine solvent systems (without inhibitor; with NTA inhibitor; and with HEEDATA inhibitor), which illustrates the temporal dynamics and variations in NH₃ emissions over time.

### DETAILED DESCRIPTION

The description which follows and the embodiments described therein are provided by way of illustration of an example or examples of particular embodiments of the principles of the present invention. In the following description of the invention, numerous examples are provided, and specific details are set forth for the purposes of explanation and not limitation in order to provide a thorough understanding of the invention. The person skilled in the art will readily appreciate that the well-known methods, procedures, and/or components will not be described as to focus on the invention in question. Accordingly, in some instances, certain structures and techniques have not been described or shown in detail in order not to obscure the invention.

It was determined that the performance of amines in carbon capture processes and the cost of such carbon capture processes can be significantly and negatively impacted by the oxidative degradation of and associated NH₃ emissions from the degradation of amine solvents used in said carbon capture processes.

In light of the above knowledge and as described in more detail elsewhere herein, the inventors have formulated and reduced to practice degradation inhibitor compositions that, when applied to certain aqueous amine solvents, enable said amine solvents to substantially outperform the oxidative degradation and NH₃ emissions characteristics of the same solvents when said solvents are used without any degradation inhibitor or with less effective degradation inhibitors. Unless context dictates otherwise, such degradation inhibitor compositions may be referred to herein as inhibitors. The term inhibitors, as used herein, may be a compound or a blend or mixture of a plurality of compounds (i.e., an “inhibitor blend” or an “inhibitor mixture”).

The stability of the amine solvent is one of the desirable properties to have for the most effective operation of the amine-based CO₂ capture. To assess the stability of solvent compositions, experiments were conducted to measure their degradation rate and ammonia (NH₃) emission. Degradation experiments were conducted on 5 M MEA used as a baseline solvent, 3.6 M Pr, and 3.6 M D single amines used in various solvent compositions, and EN23 and EN23A1 solvent compositions.

Various degradation inhibitors were also evaluated to determine their solvent degradation inhibitory effect in the various solvent systems.

### Experimental Procedure

### Degradation and NH₃ Emission Experimental Setup

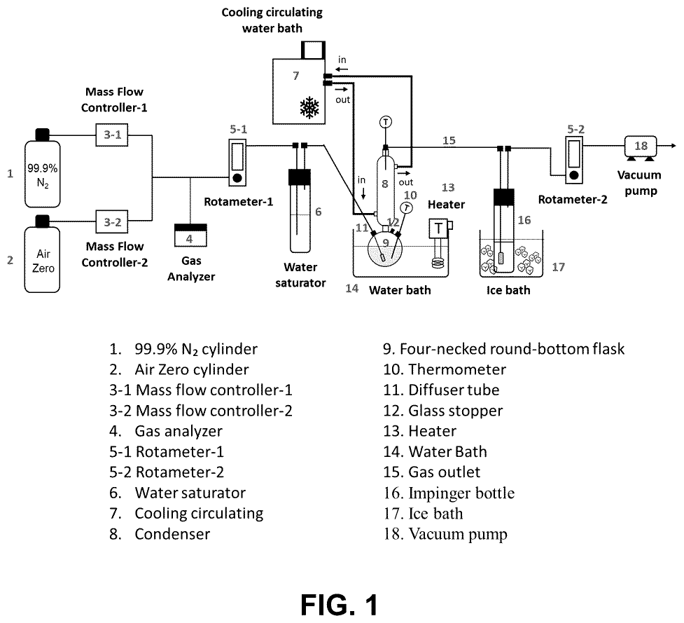

A schematic of the experimental setup is presented in FIG. 1. The experimental set-up for the oxidative degradation and NH₃ emission of the amine solution involved a 500 mL four-necked round-bottom flask (9). The central neck of this flask was connected to a condenser (8) cooled by a circulating water bath (7). The condenser outlet was maintained at the same temperature as the inlet feed gas (room temperature) to preserve moisture balance within the flask. The second neck was fitted with a thermometer (10) using an adapter to monitor the temperature of the amine solution. The third neck held a diffuser tube (11) to bubble the feed gas into the solution. The fourth neck was sealed with a glass stopper (12) to maintain a closed system.

Prior to the experiment, 250 ml of CO₂-loaded amine solution was added to the reaction flask. The solution was heated to 60±2° C. using a temperature-controlled water bath (14) equipped with a heater (13). The feed gas was a controlled mixture of 99.9% N₂ (1) and Air Zero (2) regulated respectively by their mass flow controllers (3-1 and 3-2). The gaseous mixture's CO₂ concentration was measured by a gas analyzer (4) before being directed through the first rotameter (5-1). The flow rate was maintained at 200±2 mL/min, verified using a bubble flow meter (Agilent Optiflow 420 Model). The gas stream was passed through a water saturator (6) to add moisture before entering the reaction flask. The degradation reaction began once the feed gas was bubbled in the amine solution.

Evolved NH₃ was carried through the gas outlet (15) and directed into an impinger bottle (16) containing 50 ml of 0.05 M H₂SO₄ to trap NH₃ molecules. The impinger was placed in an ice bath (17) maintained below 5° C. to improve NH₃ capture. To ensure consistent gas flow through the impinger and prevent over/under-sampling, the outlet of the impinger was connected to the second rotameter (5-2) and then to a vacuum pump (18). It was maintained at a regulated flow rate of 200±2 mL/min, consistent with the feed gas setting. Sampling was conducted for one hour, after which the impinger bottle (16) was fully disconnected from the condenser outlet. The impinger solution was transferred to a 100 mL volumetric flask. The empty impinger was then rinsed several times with fresh 0.05 M H₂SO₄, and the rinse solutions were also added to the same volumetric flask. Finally, the flask was topped up with fresh 0.05 M H₂SO₄ to reach the 100 mL calibration mark. NH₃ analysis was performed on samples collected at different time intervals.

### Water and Amine Vaporization Determination

Because water and amine vaporized during the experimental procedures, which had the potential to impact the accuracy of amine degradation rates, the rates of water and amine vaporization were determined and quantified for all experimental runs. The water and amine vaporization data were then used to re-adjust the actual amount of amine that was degraded by the oxidative reaction only.

The water loss rate was determined by subtracting the initial volume (250 ml) from the final volume and the sampling volume (1 mL per day) of the amine solution, which was then divided by the duration of the experiment, as expressed in the following equation. This process enabled us to determine the actual amine degradation that was caused solely by the oxidative reactions.

$$Rate of water vaporization ( \frac{mL}{day} ) = \frac{( Started volume - Final volume - Sample taken volume )}{Experimental days}$$

For amine vaporization, the amine vapor in the off-gas stream was collected for a period of 6 hr by condensing it into an empty impinger, which was soaked in the iced bath at 5° C. throughout the test. The condensed liquid was transferred to a 10 mL volumetric flask and adjusted to the volume with DI water. The amount of amine in the collected samples was quantified by using GC-MS. The vaporization rates of amine (mmol/day) and water (mL/day) were used to correct the amine degradation rate results.

### NH₃ Emission Analysis

The collected samples were placed in the refrigerator before being sent to Roy Romanow Provincial Lab (Regina, Saskatchewan, Canada) for quantitative analysis of NH₃ using the Ammonia/Nitrate Analyzer (Timberline Model TL-2800), which operates on the principle of gas diffusion across a membrane in conjunction with electrical conductivity measurement. This method demonstrated a high degree of precision in ascertaining NH₃ concentrations within the samples, with a method detection limit (MDL) reported at a 99% confidence level. The observed % error of the analytical results within this research ranged from 0.64% to 1.99%. This range firmly attested to the accuracy and reliability of the analytical methodology adopted in this study for the quantification of NH₃ concentrations.

The amount of NH₃ in the sample solution obtained from Roy Romanow Provincial Lab was in mg/L, which was converted to the volume concentration of NH₃ gas (C_{NH3}, ppmV) in the off-gas using the equation below,

$${C}_{{NH}_{3}} = \frac{N ( 0.1 ) ( 24.04 ) ( 0.001 ) \times {10}^{6}}{12 L \times 17 g / mol}$$

where N is the average concentration of NH₃ (mg/L) in the impinger solution, 0.1 is the conversion factor of the volume of the solution, 24.04 is the molar volume (L) at 20° C., 0.001 is the factor used to convert mg/L to g/L, 10⁶ is the conversion factor used to obtain part per million units (ppmV), 17 g/mol is the molar mass of NH₃, and 12 L is the total volume of off-gas collected for one hour (0.2 L×60 minutes). The concentrations of NH₃ (ppmV) and their corresponding times were plotted, and the areas under the curve were then determined at different time intervals using Matlab software (R2017a version). The obtained areas, representing the accumulated amounts of NH₃, were finally plotted against their corresponding times to generate the NH₃ emission profile, whose slope represented the overall rate of NH₃ emissions produced by each amine solution.
Determination of Amine concentration Using Gas Chromatographic-Mass Spectrometric (GC-MS) Technique

To determine the concentration of amine solvent remaining in each reaction investigated in this study, gas chromatography (Agilent 7890A) equipped with a mass spectrometer (Agilent 5975C inert XL MSD) was used for analysis. A capillary column of Rtx-5 amine (5% diphenyl/95% siloxane) was used to separate the target compound and quantify the decline of the amine concentration during the oxidative reaction. The amine solution sample was diluted with DI water at 10 dilution factor before analysis. The sample was automatically injected using an autosampler (Agilent G2614A)/autoinjector (Agilent G2613A). During operation, UHP helium carrier gas flowed at a constant rate of 1.4 mL/min. In a typical run, 1 μL of sample solution was injected at the GC inlet, and the temperature of the inlet injector was set at 250° C. using a split injection mode with a split ratio of 50:1.

The temperature programming details for the analysis of individual amines are presented in Table 1. Method 1 was applied for the analysis of MEA solvent, while Method 2 was employed for the analysis of D, Pr, EN23, and EN23A1 solvents. The GC-MS interface, MS quad, MS source, and EM voltage are kept at 250° C., 150° C., 230° C., and 1858, respectively, and MS scan mode is used, having a mass range from 10 to 550.

TABLE
GC-MS Method and Parameter

| GC-MS Parameter | Method 1 | Method 2 |
|---|---|---|
| Amine Types | MEA | D, Pr, EN23, |
| | | EN23A1 |

| | |
|---|---|
| Injection temperature | 250° C. |
| Carrier gas (He) | 1.4 mL/min |
| flow rate | |
| Split ratio | 50:1 |

| | | |
|---|---|---|
| Initial temperature | 70° C. for 5 min | 100° C. for 2 min |
| Heating rate | 10° C./min | 30° C./min |
| (° C./min) | | |
| Final temperature | 170° C. for 2 min | 220° C. for 6 min |

| | |
|---|---|
| GC-MS interface | 250° C. |
| MS quad | 150° C. |
| MS Source | 230° C. |
| EM voltage | 1858 |
| Mass range | 10-550 |

The products are identified by matching their mass spectra with commercial mass spectra of the National Institute of Standards and Technology (NIST) database (1998 version). The samples were analyzed three times to check for reproducibility. A matching technique which compared the mass spectra of the GC-separated components with the NIST database used for the initial product identification. Verification of some species is subsequently performed by comparing the mass spectra and the GC retention time of commercially available pure standards with those of the initially identified components.

The concentration of the amine solution was quantified using a calibration curve made of different amine concentrations prepared from each amine type. The degradation rate of each amine was determined from the declining slope of the plot between amine concentration and degradation times.

### Results

### 2.1 5 M MEA, 3.6 M D, 3.6 M Pr, EN23, and EN23A1 Solvents Using 10% O₂ Feed Gas (RUN 1)

The oxidative degradation and NH₃ emission of 5 M MEA, 3.6 M D, 3.6 M Pr, EN23, and EN23A1 solvents were studied to determine the stability of the solvents while being used to capture the CO₂. In addition to the experiments, they were carried out at 60° C. using 10% O₂ with a flow rate of 200 mL/min for all the amines previously described, an extra run was carried out on EN23 solvent with 100% N₂. This experiment was used as a baseline run to help establish the true degradation rate of EN23. As mentioned previously, the amine degradation rate determined from the experiment could be faulty if the amine and water vaporization during the experiment were not accounted for. Therefore, rates of water and amine losses via vaporization were measured and used to re-calculate the actual rates of amine degradation that were caused only by oxidative degradation.

Table 2 summarizes the rates of water and amine losses. The rates of water losses by vaporization in the off-gas of 5 M MEA, 3.6 M D, 3.6 M Pr, EN23 (with 100% N₂), EN23, and EN23A1 solvents were 1.60, 1.39, 0.31, 1.40, 1.96, and 1.53 mL/day, respectively. The amine vaporization rates of 5 M MEA, 3.6 M D, 3.6 M Pr, EN23 (with 100% N₂), EN23, and EN23A1 solvents also reported in the same table were found to be 0.79, 7.06, 0.73, 4.92, 5.49, and 0.71 mmol/day, respectively. It should be pointed out that the amine vaporization rate of EN23A1 measured based on the Pr component was much lower than that of E23 measured based on the D component. This is a substantial improvement in reducing the rate of amine vaporization of E23 to that of E23A1 by replacing the D component with the Pr. The rate of amine loss of E23A1 was also like that of the benchmark MEA solvent.

TABLE 2
Water and D-component vaporization rates of all solvents

| | | Water | Amine |
|---|---|---|---|
| | | vaporization | vaporization |
| Reaction | | rate | rate |
| cells | Solvents | (mL/day) | (mmol/day) |
| 1 | 5M MEA | 1.60 | 0.79 |
| 2 | 3.6M D | 1.39 | 7.06 |
| 3 | 3.6M Pr | 0.31 | 0.73 |
| 4 | EN23 | 1.96 | 5.49 |
| 5 | EN23 (baseline | 1.40 | 4.92 |
| | run with 100% N₂) | | |
| 6 | EN23A1 | 1.53 | 0.71 |

By considering the rates of water and amine losses in degradation rate calculations, the actual degradation rates of 5 M MEA, 3.6 M D, 3.6 M Pr, EN23 (with 100% N₂), EN23, and EN23A1 solvent compositions were determined and given in Table 16. 5 M MEA showed a degradation rate of 1.76 mM/h, which was higher than the EN23 and EN23A1 by 52% and 56%, respectively. The degradation rate of 3.6 M D was 0.84 mM/h, which was equal to that of EN23 (0.84 mM/h), that had D as the primary component. For 3.6 M Pr, the degradation rate was only 0.39 mM/h, while EN23A1, having the Pr as the primary component, showed the degradation rate of 0.77 mM/h. For the degradation of the H-component in both EN23 and EN23A1, their degradation rates were measured to be 0.05 and 0.15 mM/h, respectively.

In addition, Table 3 also presents the comprehensive NH₃ emission rates and accumulated amounts for the different amine solvents under investigation. Notably, 5 M MEA exhibited the highest NH₃ emission rate, quantified at 183.06 ppmV/h, with an accumulative NH₃ emission reaching 118,590 ppmV for the test period measured. In contrast, solvent compositions EN23 and EN23A1 demonstrated substantially lower NH₃ emission rates, measuring 8.24 and 14.35 ppmV/h, respectively, and yielding accumulative NH₃ emissions of 5,191 ppmV and 9,629 ppmV, respectively. These values represented a remarkable reduction in NH₃ release, achieving a reduction of 96% and 92% when compared to 5 M MEA. The 3.6 M D and 3.6 M Pr solvents, on the other hand, emitted NH₃ at rates of 8.23 and 0.98 ppmV/h, respectively, with corresponding accumulated NH₃ emissions of 5,458 ppmV and 634 ppmV.

As expected, all amine solvent compositions exhibited significantly higher stability than 5 M MEA, displaying over a 50% reduction in amine degradation rate and over a 90% decrease in NH₃ emissions.

TABLE 3
Degradation rate, NH₃ emission rate, water vaporization rate,
and amine vaporization rate comparison of amine solvents

| | | NH₃ emission | |
|---|---|---|---|
| | | Emission | Accumulated |
| | Degradation rate | Rate | amount |
| Solvent | (mM/h) | (ppmV/h) | (ppmV) |
| 5M MEA-10% O₂ | 1.76 | 183.06 | 118,590 |
| 3.6M D-10% O₂ | 0.84 | 8.23 | 5,458 |
| EN23-10% O₂ | 0.84 (D) 0.05 (H) | 8.24 | 5,191 |
| EN23-100% N₂ | 0.23 (D) 0.14 (H) | 5.03 | 3,252 |
| 3.6M Pr-10% O₂ | 0.39 | 0.98 | 634 |
| EN23A1-10% O₂ | 0.77 (Pr) 0.15 (H) | 14.35 | 9,629 |

### EN23 Solvent Composition With Five Different Inhibitors Using a 10% O₂ Feed Gas (RUN 2)

The objective of this experiment was to assess the effectiveness of various inhibitors on the oxidative degradation and NH₃ emission of solvent composition EN23 during its use for CO₂ capture purposes. Within this experimental study, a set of five inhibitors has been chosen for evaluation to assess their efficiency in mitigating the degradation impact observed in EN23. The selected inhibitors consisted of:
1) Citric acid (CA);
2) Sodium tartrate dibasic dehydrate (NTT);
3) Sodium bitartrate monohydrate (NBTT);
4) Nitrilotriacetic acid (NTA); and
5) N-(2-hydroxyethyl) ethylenediamine-N, N′, N″-triacetic acid (HEEDATA).

All experiments were conducted at a temperature of 60° C., using a 10% O₂ feed gas whose flow rate was set at 200 mL/min. Additionally, a control experiment was carried out which contained solvent composition EN23 being degraded without any inhibitor addition. This no-inhibitor run was performed as a baseline run and used to compare with runs with inhibitors for the inhibition performance assessment. In this study, the analyses of the rates of water and amine vaporization of all the test runs were also conducted throughout the duration of the experiment. The quantification of water and amine vaporization rates for all solvent samples is presented in Table 4.

The water losses in reaction cells 1, 2, 3, 4, and 6 were observed to be 1.25, 1.61, 0.89, 1.89, and 0.89 mL/day, respectively. However, in cell 5, water was added to the reaction system instead at a rate of 0.32 mL/day. Regarding the amine vaporization rate from this test, the D-component was still the only amine that was detected in the condensate sample using GC-MS analysis. Thus, this finding confirms that only the D-component was emitted into the off-gas phase. The vaporization rates of the D components found for sample cells 1 to 6 were 4.25, 3.45, 5.13, 7.02, 3.67, and 7.72 mmol/day, respectively.

TABLE 4
Water and D-component vaporization rates of all solvent systems

| | | Water | D- |
|---|---|---|---|
| | | vaporization | vaporization |
| Reaction | | rate | rate |
| cells | Solvents | (mL/day) | (mmol/day) |
| 1 | EN23 | 1.25 | 4.25 |
| 2 | EN23 + 0.0025M CA | 1.61 | 3.45 |
| 3 | EN23 + 0.0025M NTT | 0.89 | 5.13 |
| 4 | EN23 + 0.0025M NBTT | 1.89 | 7.02 |
| 5 | EN23 + 0.0025M NTA | −0.32 | 3.67 |
| 6 | EN23 + 0.0025M HEEDATA | 0.89 | 7.72 |

* Negative value indicates the addition of water into the system.

By factoring in the rates of water and amine losses into the degradation rate calculations, the actual degradation rates of solvent composition EN23 with and without inhibitors were summarized in Table 5. In the absence of any inhibitors in solvent composition, EN23, D-component, and H-component degradation rates were found to be 1.07 and 0.06 mM/h, respectively. However, upon introducing 0.0025 M CA inhibitor to EN23, the D-component and H-component degradation rates were increased to 1.16 and 0.08 mM/h, respectively. From this finding, it appears that the use of a 0.0025 M CA inhibitor may not be appropriate for the solvent composition EN23 since it seems to act as a pro-oxidant rather than an anti-oxidant.

In the case of 0.0025 M NTT inhibitor, it reduced solvent composition EN23′s degradation rate to 0.47 and 0.03 mM/h for D- and H-components, respectively. The degradation reductions of D- and H-respectively, corresponded to 56% and 50% inhibition efficiencies.

The 0.0025 M NBTT inhibitor led to a reduction in the D-component degradation rate to 0.85 mM/h and had no significant effect on the H-component, which remained at 0.08 mM/h. This corresponds to an inhibition efficiency of 21% for the D-component, while no inhibition was observed for the H-component.

The 0.0025 M NTA inhibitor was also able to respectively lower degradation rates, with D-component and H-component degradation rates of 0.30 and 0.01 mM/h that corresponded to the inhibitions of 72% and 83%.

Notably, among all systems, solvent composition EN23 with 0.0025 M HEEDATA inhibitor exhibited the lowest degradation rates, with D-component and H-component degradation rates of 0.22 and 0.03 mM/h that corresponded respectively to the inhibitions of 79% and 50%.

TABLE 5
Comparative analysis of degradation rates, NH₃ emission
rates, and accumulated Amount of NH₃ emission of
EN23 in the presence and absence of inhibitors

| | | | NH₃ Emission | |
|---|---|---|---|---|
| | Degradation | | | Accumulated |
| | rate (mM/h) | | Rate | Amount |
| Solvents | D | H | (ppmV/h) | (ppmV) |
| EN23 | 1.07 | 0.06 | 7.50 | 4845 |
| EN23 + 0.0025M CA | 1.16 | 0.08 | 6.57 | 3816 |
| EN23 + 0.0025M NTT | 0.47 | 0.03 | 6.02 | 3937 |
| EN23 + 0.0025M NBTT | 0.85 | 0.08 | 10.46 | 6250 |
| EN23 + 0.0025M NTA | 0.30 | 0.01 | 5.89 | 3796 |
| EN23 + 0.0025M HEEDATA | 0.22 | 0.03 | 7.56 | 5001 |

The rates and accumulated amount of NH₃ emission of all the solvents were carefully analyzed and are also presented in Table 5. In the absence of any inhibitor, solvent composition EN23 exhibited an NH₃ emission rate of 7.50 ppmV/h with an accumulated amount of 4,845 ppmV. However, when 0.0025 M CA inhibitor was introduced to solvent composition EN 23, a reduction in NH₃ emission rate was observed, which was measured at 6.57 ppmV/h, corresponding to a 12% decrease from that of the run without any inhibitor. Similarly, solvent composition EN23 with 0.0025 M NTT inhibitor had a lower NH₃ emission rate of 6.02 ppmV/h than the base run. This rate shows a 20% inhibition compared to the absence of an inhibitor. On the other hand, when 0.0025 M NBTT inhibitor was used in solvent composition EN23, the NH₃ emission rate increased from that of the base run to 10.45 ppmV/h. This suggests that the presence of NBTTT did not effectively suppress NH₃ emissions and may have even contributed to its release. In contrast, the use of 0.0025 M NTA inhibitor in solvent composition E23 was the most effective among all the tested solvents as it resulted in the lowest NH₃ emission rate of 5.89 ppmV/h. This rate was able to provide a significant 21% inhibition. Furthermore, solvent composition EN23 with 0.0025 M HEEDATA inhibitor exhibited an NH₃ emission rate of 7.56 ppmV/h with 5,001 ppmV accumulated amount.

When evaluating the degradation rate and NH₃ emission results derived from the EN23 solvent in the presence of each inhibitor, it was evident that NTA and HEEDATA inhibitors demonstrated the highest inhibition efficiency concerning the degradation rate, surpassing the other three inhibitors. Given that the degradation rate provides a more direct indicator of solvent composition stability compared to NH₃ emission, NTA and HEEDATA were chosen for further investigation with another amine-based solvent, EN23A1.

### EN 23A1 Solvent System With NTA and HEEDATA Inhibitors Using a 10% O₂ Feed Gas (RUN 3)

In this experiment, NTA and HEEDATA inhibitors, chosen based on their performance in previous tests with EN23 solvent, have been used with the EN23A1 solvent. These inhibitors were utilized at a concentration of 0.0025 M to assess their effectiveness in cutting down the rates of degradation and NH₃ emissions in the EN23A1 solvent. The degradation and NH₃ emission experimental procedures and conditions, along with the characterization techniques used in this experiment, were identical to those employed in the initial degradation tests on EN23 solvent. All experiments were conducted for 28 days at a temperature of 60° C. The 10% O₂ with a flow rate of 200 mL/min was used as a degrading feed gas. Additionally, a control degradation experiment of EN23A1 tested without any inhibitor was performed as a baseline run which was used to compare with runs with the inhibitors.

An accurate measurement of rates of the water and amine vaporization was also taken throughout the duration of the experiment and used to calculate the amine degradation rate of the solvent. Measurements of the water and amine vaporization rates for all solvent samples are presented in Table 6. The water losses in reaction cells 1 and 3 were the same which were measured to be 0.54 mL/day. In the case of cell 2, instead of water being lost from the cell, water was added to the reaction system at a rate of 0.25 mL/day. Regarding the amine vaporization rate, only the Pr-component was detected in the condensate sample by the GC-MS analysis. This finding confirms that only the Pr-component was emitted in the off-gas phase. The Pr-component emission via vaporization varied across the sample cells 1, 2, and 3 with values of 1.69, 0.52, and 2.08 mmol/day, respectively.

TABLE 6
Water and Pr-component vaporization rates of EN23A1, EN23A1
with 0.0025M NTA, and EN23A1 with 0.0025M HEEDATA

| | | Water | Pr- |
|---|---|---|---|
| | | vaporization | vaporization |
| Reaction | | rate | rate |
| cells | Solvents | (mL/day) | (mmol/day) |
| 1 | EN23A1 | 0.54 | 1.69 |
| 2 | EN23A1 + | −0.25 | 0.52 |
| | 0.0025M NTA | | |
| 3 | EN23A1 + | 0.54 | 2.08 |
| | 0.0025M HEEDATA | | |

* Negative value indicates the addition of water into the system.

Accounting for the rates of water and amine losses in the degradation rate calculations, the degradation rates of EN23A1, both with and without inhibitors, were determined and are presented in Table 7. In the absence of any inhibitors, EN23A1 solvent degraded at the rates of 1.09 mM/h for the Pr-component and 0.24 mM/h for the H-component. When 0.0025 M of the NTA inhibitor was introduced into the EN 23A1 solvent system, it effectively lowered the Pr-component degradation rate to 0.91 mM/h. This rate marked a notable 17% reduction compared to the rate observed in the absence of the inhibitor. The H-component degradation rate measured to be 0.30 mM/h was not much different from the without inhibitor rate. When solvent composition EN23A1 was tested with the 0.0025 M HEEDATA inhibitor, the Pr-component's degradation rate was cut down significantly to 0.55 mM/h, giving close to 50% rate reduction. The H-component degradation rate obtained for this inhibitor was 0.21 mM/h which was in the same order of magnitude as that of the baseline run.

TABLE 7
Comparison of degradation rates, NH₃ emission
rates, and accumulated NH₃ emission for EN23A1
in the presence and the absence of inhibitors

| | | | NH₃ | Accumulated |
|---|---|---|---|---|
| | Degradation | | Emission | amount of |
| | Rate (mM/h) | | Rate | NH₃ Emission |
| Solvent | Pr | H | (ppmV/h) | (ppmV) |
| EN23A1 | 1.09 | 0.24 | 7.88 | 5582 |
| EN23A1 + | 0.91 | 0.30 | 7.00 | 4834 |
| 0.0025M NTA | | | | |
| EN23A1 + | 0.55 | 0.21 | 4.95 | 3646 |
| 0.0025M HEEDATA | | | | |

The NH₃ emission rates and quantities for all solvent composition EN23A1 were thoroughly examined and are also summarized in Table 7. Without any inhibitors, solvent composition EN 23A1 displayed an accumulated NH₃ emission of 5,582 ppmV over a period of 28 days, accompanied by an overall NH₃ emission rate of 7.88 ppmV/h. With the 0.0025 M NTA in solvent composition EN23A1, a reduction in NH₃ emission rate was however observed. The NH₃ emission rate of solvent composition EN23A1 with the presence of this inhibitor reduced to 7.00 ppmV/h, resulting in a cumulative quantity of 4834 ppmV. With this NH₃ emission rate and quantity observed from NTA, this inhibitor was able to lower the NH₃ emission amount and the rate by 11% and 13%, respectively. Similarly, solvent composition EN23A1 with 0.0025 M HEEDATA inhibitor displayed the lowest NH₃ emission rate of 4.95 ppmV/h with the amount of 3646 ppmV, which decreased from those of the baseline run by 37% and 35%, respectively.

Significantly, the performance of NTA and HEEDATA inhibitors at a concentration of 0.0025 M as degradation inhibitors for solvent composition EN23A1 was observed to be somewhat less effective than when used in solvent composition EN23. These inhibitors yielded only a 17% and 50% inhibition efficiency for the Pr-component, as well as approximately a 10% and 35% reduction in NH₃ emission rate and quantity, which may be attributed to the fixed concentration of these inhibitors at 0.0025 M. Further refinement of NTA and HEEDATA concentration within solvent composition EN23A1 is necessary to enhance the solvent's stability in the context of oxidative degradation.

EN23A1 Solvent System With NTA and HEEDATA Inhibitors Using 5 ppm SO₂/25ppm NO₂/10% O₂ Feed Gas (RUN 4)

In this experiment, the solvent composition EN23A1 was also subjected to test with 0.0025 M NTA and 0.0025 M HEEDATA inhibitors under the condition of a feed gas composition containing 5 ppm SO₂/25 ppm NO₂/10% O₂. The objective was to investigate the behavior of these inhibitors when the feed gas contains SO₂ and NO₂. This experiment was conducted for 17 days at a temperature of 60° C. Furthermore, two control degradation experiments for solvent composition EN23A1 without the use of any inhibitors as baseline runs serve as reference points for result accuracy in comparison to the experiments involving inhibitors.

Consistent with previous tests, the rates of water and amine vaporization were measured throughout the experiment to accurately ascertain the amine degradation rate of the solvent. Measurements of the water and amine vaporization rates for all solvent samples are presented in Table 8. The water losses in reaction cells 1, 2, 3, and 4 were measured to be 0.71, 1.61, 1.00, and 1.64 mL/day, respectively. Regarding the amine vaporization rate, only the Pr-component was detected in the condensate sample by the GC-MS analysis. This finding confirms that only the Pr-component was emitted in the off-gas phase. The Pr-component emission via vaporization varied across the sample cells 1, 2, 3, and 4 with values of 1.05, 1.21, 1.21, and 1.36 mmol/day, respectively.

TABLE 8
Water and Pr-component vaporization rates of all solvent systems

| | | Water | Pr- |
|---|---|---|---|
| | | vaporization | vaporization |
| Reaction | | rate | rate |
| cells | Solvents | (mL/day) | (mmol/day) |
| 1 | EN23A1 | 0.71 | 1.05 |
| 2 | EN23A1 | 1.61 | 1.21 |
| 3 | EN23A1 + | 1.00 | 1.21 |
| | 0.0025M NTA | | |
| 4 | EN23A1 + | 1.64 | 1.36 |
| | 0.0025M HEEDATA | | |

Considering the rates of water and amine losses in the degradation rate calculations, the degradation rates of solvent composition EN23A1, both with and without inhibitors, were calculated and summarized in Table 9. In the absence of any inhibitors, solvent composition EN23A1 exhibited degradation rates of 2.60 mM/h for the Pr-component and 0.16 mM/h for the H-component. The introduction of the 0.0025 M NTA inhibitor in the solvent composition EN23A1 effectively reduced the Pr-component degradation rate to 1.73 mM/h, representing a notable 33% reduction compared to the rate observed without the inhibitor. The H-component degradation rate remained similar to that observed without the inhibitor at 0.16 mM/h. In the solvent composition, EN23A1 with 0.0025M HEEDATA inhibitor resulted in a significant reduction in both the Pr-component and H-component degradation rates, which were reduced to 1.37 and 0.06 mM/h, respectively, corresponding to 47% and 63% rate reduction.

TABLE 9
Degradation rates, NH₃ emission rates, and the accumulated amount
of NH₃ emission of EN23A1 with and without inhibitors under
different feed gas compositions. (17 days experiment)

| | | | | NH₃ | Accumulated |
|---|---|---|---|---|---|
| | | Degradation | | emission | amount of |
| Feed gas | | rate (mM/h) | | rate | NH₃ emission |
| composition | Solvents | Pr | H | (ppmV/h) | (ppmV) |
| 5 ppmSO₂/ | EN23A1 | 2.60 | 0.16 | 8.03 | 3259 |
| 25 ppmNO₂/ | EN23A1 + | 1.73 | 0.16 | 7.49 | 3228 |
| 10% O₂ | 0.0025M NTA | | | | |
| | EN23A1 + | 1.37 | 0.06 | 6.35 | 2885 |
| | 0.0025M | | | | |
| | HEEDATA | | | | |
| 10% O₂ | EN23A1 | 1.15 | 0.34 | 7.15 | 3299 |
| | EN23A1 + | 0.93 | 0.30 | 5.13 | 2270 |
| | 0.0025M NTA | | | | |
| | EN23A1 + | 0.67 | 0.21 | 2.91 | 1449 |
| | 0.0025M | | | | |
| | HEEDATA | | | | |

The NH₃ emission rates of all solvents analyzed during the test are also presented in Table 9. In the absence of any inhibitors, solvent composition EN23A1 exhibited the accumulated amount of NH₃ emission of 3259 ppmV with an overall NH₃ emission rate of 8.03 ppmV/h. With the 0.0025 M NTA in the EN23A1, a reduction in NH₃ emission rate was however observed. The rate of emission of this inhibitor came down to 7.49 ppmV/h with the accumulated amount of NH₃ at 3228 ppmV. With these rates and the amount of NH₃ emission observed from NTA, the inhibitor was able to lower the NH₃ emission rate and amount by only 7% and 1%, respectively. In EN23A1 with 0.0025 M HEEDATA inhibitor, it displayed a lower amount of NH₃ emission of 2885 ppmV with a rate of 6.35 ppmV/h, which decreased from those of the baseline run by 11% and 21%, respectively.

Moreover, the results obtained from the previous run (Run 3) involving EN23A1 with 0.0025 M NTA and 0.0025 M HEEDATA inhibitors, run with a 10% O₂ feed gas, were also analyzed based on the 17-day data to assess the impact of these two inhibitors when exposed to distinct feed gases. As clearly shown from the data presented in Table 9, both the degradation rate and NH₃ emission of EN23A1, obtained with or without the two inhibitors, were higher in a 5 ppm SO₂/25 ppm NO₂/10% O₂ feed gas than the rate values observed with a 10% O₂ feed gas. Furthermore, upon evaluating the inhibition efficiency, it was evident that NTA and HEEDATA were more effective in inhibiting the degradation in the condition of 10% O₂ than the O₂—SO₂—NO₂ feed gas system. This clearly shows the degrading power of SO₂ and NO₂ whose effects are added up to the effect of O₂-induced amine degradation. Therefore, the current concentration of 0.0025M for NTA and HEEDATA inhibitors used on E23A-1 solvent cannot provide sufficient inhibitive effect to fight against SO₂ and NO₂ degradation. Hence, further tests must be carried out to determine the most effective concentrations of NTA and HEEDATA that can provide up to 90% inhibition against the effect of solvent composition EN23A1 degradation induced by not only O₂ but also SO₂ and NO₂.

All tested amine solvent compositions comprising 3.6 M D, 3.6 M Pr, EN23, and EN23A1 consistently showed higher degradation stability under 10% O₂ feed gas than the benchmark amine (5 M MEA). The tested amines all have amine degradation and NH₃ emission rates being 50% and 90% lower than the MEA, respectively.

In the context of inhibitor assessment in the solvent composition, EN23A1 was tested using the 10% O₂ feed gas condition, and NTA and HEEDATA inhibitors were found to be the most effective inhibitors. Specifically, NTA provided an inhibition efficiency of 72% for the D-component degradation and 83% for the H-component degradation. HEEDATA exhibited inhibition efficiencies of 79% for the D-component degradation and 50% for the H-component degradation. Based on this finding, NTA and HEEDATA were selected for subsequent investigations on the solvent composition EN23A1.

In solvent composition EN23A1 tested under the 10% O₂ feed gas condition, NTA and HEEDATA inhibitors used at the concentration of 0.0025 M did not provide the same level of effect that was observed previously in solvent composition EN23. These inhibitors showed small Pr degradation inhibition efficiencies of only 17% and 50%, respectively. The NH₃ emission reductions by NTA and HEEDATA were also small being measured respectively at 10% and 35% reductions in NH₃ emission rate and quantity. The observed decrease in the effectiveness of both inhibitors is likely due to the ineffective concentration at 0.0025 M being used with the solvent. This has urged the need for more experiments to further fine-tune and optimize the NTA and HEEDATA concentrations for the EN23A1 solvent.

The degradation and NH₃ emissions became more intense in solvent composition EN23A1 when the amine was tested under the 5 ppm SO₂/25 ppm NO₂/10% O₂ feed gas condition. Both the degradation rate and NH₃ emission with (0.0025 M)/without inhibitors exceeded the values derived from the EN23A1 run tested only with a 10% O₂ feed gas. This phenomenon showed a strong add-on effect of SO₂ and NO₂ degradation on E23A-1 solvent, and 0.0025 M concentrations of both inhibitors were ineffective, thus not having enough inhibitory power to minimize the degradation and NH₃ emission to acceptable levels. Therefore, more tests are required to further optimize NTA and HEEDATA concentrations that can provide up to or higher than 90% degradation inhibition for solvent composition EN23A1 when in contact with O₂, SO₂, and NO₂.

Even though the solvent composition EN23A1 degrades 50% less than MEA, the cost of E23A1 is about 9 times that of MEA. Therefore, it is desirable to use an effective inhibitor to drastically reduce the degradation rate by 90% to reduce the cost implications of solvent composition EN23A1 makeup replacement. With this 90% drastic reduction in solvent degradation coupled with its high capture efficiency of about 95% and a significant reduction in the heat duty relative to MEA, the overall economics of the capture process will be extremely attractive when using the solvent composition EN23A1.

According to a preferred embodiment of the present invention, the inhibitor comprises nitrilotriacetic acid (NTA), having a chemical formula of N(CH₂COOH)₃.

According to a preferred embodiment of the present invention, the inhibitor comprises N-(2-hydroxyethyl)ethylenediamine-N′, N′, N″-triacetic acid (HEEDATA), having a chemical formula of HOCH₂CH₂N(CH₂CO₂H)CH₂CH₂N(CH₂CO₂H)₂.

Certain amine solvents with desirable absorption and desorption profiles in a PCCC process are subject to oxidative degradation and would be lost in the carbon capture process, resulting in unwanted degradation byproducts, NH₃ emissions, and lost efficiency in both absorption and desorption units. Some desirable amine solvents comprise one or both of 1-(2-hydroxyethyl)pyrrolidine (PR) and hexamethylenediamine (HMDA).

Two sets of experiments were carried out with feed gas compositions of 5 ppm SO₂/25 ppm NO₂/10% O₂ and 10% O₂, respectively. Both experiments were conducted at the same temperature of 60° C. Each experimental set contained identical amine solvent compositions comprising PR present in a molar concentration of 3.6 M; HMDA present in a molar concentration of 1.0 M; and PEI present in a molar concentration of 0.01 M (such composition hereinafter referred to as “EN23A1”).

The experiments were carried out with: EN23A1 without any inhibitor, EN23A1 with 0.0025 M NTA, and EN23A1 with 0.0025 M HEEDATA. The feed gas flow rate set for all experiments was 200 mL/min. The no-inhibitor runs in both sets of experiments serve as the baseline runs which are used to assess the inhibition performance of the runs with inhibitors. The detailed experimental conditions are provided in Table 10.

TABLE 10
Experimental conditions of oxidative degradation
study on the EN23A1 solvent mixtures

| | | Feed gas | |
|---|---|---|---|
| Solvent | Inhibitor | composition | Operating condition |
| EN23A1 | No inhibitor | 10% O₂ | Feed gas flow rate: |
| | 0.0025M NTA | | 200 mL/min |
| | 0.0025M HEEDATA | | Degradation temp.: |
| | No inhibitor | 5 ppm | 60° C. |
| | 0.0025M NTA | SO₂/25 ppm | Period: 28 days |
| | 0.0025M HEEDATA | NO₂/10% O₂ | |

The rates of water and amine vaporization for all the test runs were analyzed throughout the experimental duration. The rates of amine and water losses determine the reliability and accuracy of the calculation of the amine degradation rates. PR vaporization rates for all EN23A1 solvent systems measured up to the current time of experiment are summarized in Table 11. The PR amine vaporization results indicate that the PR-component is the only amine detected in the condensate sample, as confirmed by the gas chromatographic-mass spectrometric (GC-MS) analysis. This indicates that the PR-component was the only amine from EN23A1 emitted into the off-gas phase. The average rate of PR vaporization for sample cells #1 to 6 were 1.53, 1.21, 1.51, 1.65, 0.73, and 1.89 mmol/day, respectively.

TABLE 11
PR-component vaporization rates of all solvents
determined by 0.1N HCl titration

| | | PR- vaporization rate | | | | | | |
|---|---|---|---|---|---|---|---|---|
| Reaction | | (mmol/day) | | | | | | |
| cells | Solvents | 1 | 2 | 3 | 4 | 5 | 6 | Ave. |
| 1 | EN23A1 | 1.08 | 1.4 | 1.5 | 1.6 | 2 | 1.6 | 1.53 |
| 2 | EN23A1 + | 0.96 | 1.5 | 1.2 | 1.2 | 1.2 | 1.2 | 1.21 |
| | 0.0025M NTA | | | | | | | |
| 3 | EN23A1 + | 1.68 | 1.2 | 1.1 | 1.4 | 1.5 | 2.2 | 1.51 |
| | 0.0025M HEEDATA | | | | | | | |
| 4 | EN23A1 | 1.2 | 1.3 | 1.8 | 1.8 | 1.6 | 2.2 | 1.65 |
| 5 | EN23A1 + | 0.48 | 0.6 | 0.8 | 0.8 | 0.9 | 0.8 | 0.73 |
| | 0.0025M NTA | | | | | | | |
| 6 | EN23A1 + | 0.96 | 1.8 | 1.6 | 3 | 2 | 2 | 1.89 |
| | 0.0025M HEEDATA | | | | | | | |

The NH₃ emission rates of all solvent compositions EN23A1 were also examined, and the results are presented in Table 12. For the experiments conducted under the conditions of 5 ppm SO₂/25 ppm NO₂/10% O₂ feed gas, in the absence of any inhibitors, solvent composition EN23A1 exhibited an NH₃ emission rate of 5.84 ppmV/h. However, the NH₃ emission rate increased to 6.82 ppmV/h when 0.0025 M NTA inhibitor was added to the amine, which corresponded to a 16.78% increase. The opposite trend was seen in the 0.0025 M HEEDATA inhibitor, which resulted in a lower NH₃ emission rate of 4.26 ppmV/h. This rate corresponded to a reduction of 27.05% compared to the base run. Under the condition of 10% O₂ as the feed gas, EN23A1 without any inhibitor, exhibited an NH₃ emission rate of 5.17 ppmV/h. However, the NH₃ emission rate decreased to 4.40 ppmV/h when 0.0025 M NTA inhibitor was added to the EN23A1 solvent. The rate was reduced by 14.89% from that of the run without any inhibitor. The use of 0.0025 M HEEDATA inhibitor was found to be the most effective in terms of limiting the emissions of NH₃, which was evident from the lowest NH₃ emission rate of 3.68 ppmV/h. This rate shows a decrease of 28.82% from the NH₃ emission rate obtained from the base run.

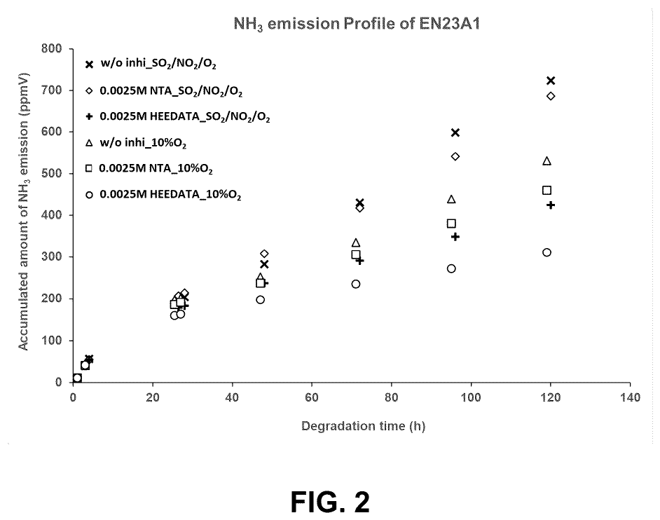

The accumulated amount of NH₃ emissions for all the tests was also assessed and summarized in Table 12. Solvent composition EN23A1 without any inhibitor carried out under the condition of 5 ppm SO₂/25 ppm NO₂/10% O₂ shows the highest NH₃ emission amount of 723.3 ppmV after 5 days of experiment. With the inclusion of 0.0025 M NTA inhibitor, the NH₃ concentration decreased to 686.3 ppmV, which was a 5.12% decrease compared to the run without any inhibitor. NH₃ concentration was even lower with the use of 0.0025 M HEEDATA inhibitor, which was found to be 424.7 ppmV. This shows a remarkable reduction of 41.28% compared to the base run. The trend found from SO₂ and NO₂ systems was also observed in the 10% O₂ feed gas system; solvent composition EN23A1 without any inhibitor exhibited the highest NH₃ emission of 530.4 ppmV. With the addition, the NH₃ emission decreased to 460.5 ppmV and 311.2 ppmV when 0.0025 M NTA inhibitor and 0.0025 M HEEDATA inhibitor were used. These concentrations of NH₃ found from NTA and HEEDATA respectively corresponded to 13.18% and 41.33% decreases from the base run. The data is reported in FIG. 2 in the form of daily measurements over the duration of the experiment.

TABLE 12
NH₃ emission rate and accumulated NH₃ emission
of EN23A1 solvents (5 days' results)

| | | NH₃ Emission - 5 days | | | |
|---|---|---|---|---|---|
| | | | | Accumulated | |
| | | rate | % | amount | % |
| Feed Gas | Solvents | (ppmV/h) | inhibition | (ppmV) | inhibition |
| 5 ppmSO₂/ | EN23A1 | 5.84 | 0.00 | 723.3 | 0.00 |
| 25 ppmNO₂/ | EN23A1 + | 6.82 | 16.78 | 686.3 | −5.12 |
| 10% O₂ | 0.0025M NTA | | | | |
| | EN23A1 + | 4.26 | −27.05 | 424.7 | −41.28 |
| | 0.0025M | | | | |
| | HEEDATA | | | | |
| 10% O₂ | EN23A1 | 5.17 | 0.00 | 530.4 | 0.00 |
| | EN23A1 + | 4.40 | −14.89 | 460.5 | −13.18 |
| | 0.0025M NTA | | | | |
| | EN23A1 + | 3.68 | −28.82 | 311.2 | −41.33 |
| | 0.0025M | | | | |
| | HEEDATA | | | | |

The examples and corresponding diagrams used herein are for illustrative purposes only. The principles discussed herein with reference to membrane systems or apparatuses can be implemented in other systems and apparatuses. Different configurations and terminology can be used without departing from the principles expressed herein. For instance, steps, equipment, components, and modules can be added, deleted, modified, or re-arranged without departing from these principles.

Unless the context clearly requires otherwise, throughout the description and the claims: “comprise,” “comprising,” and the like are to be construed in an inclusive sense, as opposed to an exclusive or exhaustive sense; that is to say, in the sense of “including, but not limited to.” “Herein,” “above,” “below,” and words of similar import, when used to describe this specification, shall refer to this specification as a whole and not to any particular portions of this specification. “Or” in reference to a list of two or more items, covers all of the following interpretations of the word: any of the items in the list, all of the items in the list, and any combination of the items in the list. The singular forms “a”, “an”, and “the” also include the meaning of any appropriate plural forms.

Where a component is referred to above, unless otherwise indicated, reference to that component should be interpreted as including as equivalents of that component, any component which performs the function of the described component (i.e., that is functionally equivalent), including components which are not structurally or compositionally equivalent to the disclosed structure or composition which performs the function in the illustrated exemplary implementations of the invention.

Specific examples of compositions, systems, methods and apparatuses have been described herein for purposes of illustration. These are only examples. M any alterations, modifications, additions, omissions, and permutations are possible within the practice of this invention. This invention includes variations on described compositions that would be apparent to the skilled addressee, including variations obtained by replacing features, elements and/or chemical compounds with equivalent features, elements and/or chemical compounds; mixing and matching of features, elements and/or chemical compounds from different examples; combining features, elements and/or chemical compounds from examples as described herein with features, elements and/or chemical compounds of other technology; omitting and/or combining features, elements and/or chemical compounds from described examples.

It is therefore, intended that the following appended claims and claims hereafter introduced are interpreted to include all such modifications, permutations, additions, omissions, and sub-combinations as may reasonably be inferred. The scope of the claims should not be limited by the preferred embodiments set forth in the examples but should be given the broadest interpretation consistent with the description as a whole.

1. A degradation inhibitor composition for minimizing oxidative degradation of an amine solvent composition and associated NH₃ emissions in a post-combustion carbon capture process, said degradation inhibitor is selected from the group consisting of: nitrilotriacetic acid (NTA); N-(2-hydroxyethyl) ethylenediamine-N′, N′, N″-triacetic acid (HEEDATA); and combinations thereof.

2. The composition as claimed in claim 1, wherein a total molar concentration of the degradation inhibitor is in the range of 0.0001 M to 0.05 M.

3. The composition as claimed in claim 1, wherein said degradation inhibitor reduces a degradation rate of a 1-(2-hydroxyethyl)pyrrolidine (PR) component in said amine solvent below a rate of 1.00 mM/h.

4. The composition as claimed in claim 1, wherein said degradation inhibitor reduces a degradation rate of a hexamethylenediamine (HMDA) component in said amine solvent below a rate of 0.50 mM/h.

5. The composition as claimed in claim 1, wherein said degradation inhibitor reduces an NH₃ emission rate from said amine solvent below a rate of 8.00 ppmV/h.

6. A method of minimizing the effects of the oxidative degradation of an amine solvent composition in a post-combustion carbon capture process, comprising the steps of:
(a) providing a means to combine said amine solvent composition with a degradation inhibitor selected from the group consisting of: nitrilotriacetic acid (NTA); N-(2-hydroxyethyl) ethylenediamine-N′, N′, N″-triacetic acid (HEEDATA); and combinations thereof;
(b) providing said amine solvent;
(c) exposing said amine solvent to said means to combine said amine solvent with said degradation inhibitor;
(d) collecting a flue gas comprising carbon dioxide from a flue gas emitting source; and
(e) exposing the treated amine solvent to said flue gas for a period of time sufficient to remove at least a portion of said carbon dioxide gas present in said flue gas.

7. Use of the composition as claimed in claim 1 to treat an amine solvent used in a post-combustion carbon capture process by exposing said degradation inhibitor to said amine solvent, thereby minimizing the oxidative degradation of said amine solvent in said carbon capture process.
